(19) United States
(12) Patent Application Publication
(10) Pub. No.: US 2013/0073418 A1
(43) Pub. Date: Mar. 21, 2013

(54) METHODS FOR COMMUNICATING MILITARY DECORATION RACK DESIGNS

(71) Applicant: Jared Zabaldo, Milwaukie, OR (US)

(72) Inventor: Jared Zabaldo, Milwaukie, OR (US)

(21) Appl. No.: 13/435,826

(22) Filed: Mar. 30, 2012

Related U.S. Application Data
(63) Continuation-in-part of application No. 13/239,196, filed on Sep. 21, 2011.

(51) Int. Cl. G06Q 30/00

(52) U.S. Cl. 705/26.5

(57) ABSTRACT

A method for communicating military decoration rack designs designed by a user, including the steps of providing a military decoration rack production system in data communication with a computer network, generating a generated decoration rack design in response to user input from the user, and communicating to a social media site the generated decoration rack design. Some examples include displaying a rendering of the generated decoration rack design on the social media site. The military decoration rack production system comprising may include an input interface, a storage unit storing instruction data including an arrangement module configured to generate a decoration rack design, and a processing unit. Some examples may include displaying a design link configured to direct social media participants to the military decoration rack production system. Further examples may include distributing a rendering of the generated decoration rack design to social media participants.

### CLAIM OF PRIORITY

This application claims priority to copending U.S. application Ser. No. 13/239,196, filed on Sep. 21, 2011, which is hereby incorporated by reference for all purposes.

### BACKGROUND

The present disclosure relates generally to systems for producing military decoration racks. In particular, systems for producing military decoration racks including kiosks used to electrically communicate data to production facilities are discussed.

Known systems for producing military decoration racks are not entirely satisfactory for the range of applications in which they are employed. For example, military decoration racks are traditionally ordered by working with an agent at an Army and Air Force Exchange Service (“AAFES”) store. This often requires the customer to wait for an extended period to speak with an available agent. Additionally, ordering from an agent in this manner provides the user with little visual feedback corresponding to their order. This, combined with possible human error on the part of the agent may lead to rack design and/or production errors. When errors do occur, the current system often produces inadequate records, as no electronic confirmation of the orders are produced for the customer.

Additionally, AAFES agents often struggle to provide the accurate price a completed rack to a customer. This often occurs because the ordering process is complex and manually keeping track of an accurate price as the rack is modified is difficult. Notably, AAFES agents generally lack any automated systems that tabulate the price of the completed rack as the rack is designed. As another issue, current systems are not adept at segregating costs for each individual rack; this also results from the lack of automated billing in the AAFES ordering process.

Traditional rack ordering methods also unsatisfactory use AAFES agents as middle men for the ordering process without any direct communication between the customer and the rack supplier. Traditional rack ordering methods also result in communication errors and may lead to improper orders being submitted. AAFES agents also must provide customer service for issues beyond the ordering process, such as dealing with repairs and returns, which is troublesome, as AAFES are often unsuited or unable to handle these post-sale customer service issues,

Other known systems may implement software methods for arranging the rack. For example, the EZ RACK BUILDER system provided at http://www.ezrackbuilder.com/ implements a software method to produce military racks. However, the EZ RACK BUILDER system is not completely satisfactory and can be improved upon. Although EZ RACK BUILDER serves as a useful tool for an individual, it is designed for use on a home computer. A user at home is not afforded any in-person assistance to help them design their rack at the point of sale, as is available when purchasing from an AAFES agent.

Thus, there exists a need for systems for producing military decoration racks that improve upon and advance the design of known systems for producing military decoration racks. Examples of new and useful systems for producing military decoration racks relevant to the needs existing in the field are discussed below.

In addition to providing a system for designing military decoration racks, there exists a need for elegant means for communicating new rack designs and amendments to others who may be interested, such as friends and acquaintances. Social media sites, such as Facebook®, Google+®, LinkedIn®, and MySpace® provide mediums through which users are linked to large numbers of such interested parties,

These sites, however, lack an elegant means of communicating rack designs generated by military decoration rack production systems or other rack designers. Further, many known military decoration rack production systems or other rack designers do not adequately interface with such social media sites to communicate rack designs. Thus, there exists a need for a methods of elegantly interfacing military decoration rack production systems or other rack designers with social media sites.

### SUMMARY OF THE INVENTION

The present disclosure is directed to methods for communicating military decoration rack designs designed by a user, including the steps of providing a military decoration rack production system data communication with a computer network, generating a generated deco ratio rack design in response to user input from the user, and communicating to a social media site the generated decoration rack design. The military decoration rack production system comprising may include an input interface, a storage, unit storing instruction data including an arrangement module configured to genera e a decoration rack design, and a processing unit. Some examples include displaying a rendering of the generated decoration rack design on the social media site. Other examples may Jude displaying a design link configured to direct social media participants to the military decoration rack production system. Further examples may include distributing a rendering of the generated decor on rack design to social media participants.

### BRIEF DESCRIPTION OF THE DRAWINGS

FIG. 1 is a schematic of a first example of a system for producing military decoration racks.

FIG. 2 is a perspective view of a kiosk a military related retail space being used by the system shown in FIG. 1,

FIG. 3 is a schematic view of a storage unit used by the system shown in FIG. 1 with instruction data shown in detail.

FIG. 4 is a front view of an example of a military decoration rack in which the system shown in FIG. 1 is capable of producing.

FIG. 5 is a schematic of a second example of a system for producing military racks.

FIG. 6 is a flow diagram of an example of a method for communicating military decoration rack designs.

FIG. 7 is a screenshot illustrating an example of a design interface displayed on a website hosted by a military decoration rack production system.

FIG. 8 is a screenshot illustrating a first example of a user page illustrated on a social media site.

FIG. 9 is a screenshot illustrating a second example of a user page illustrated on a social media site.

FIG. 10 is a screenshot illustrating a third example of a user page illustrated a social media site.

FIG. 11 is a screenshot illustrating a fourth example of a user page illustrated on a social media site.

### DETAILED DESCRIPTION

The disclosed systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various systems are provided. Related features in the examples may be identical, similar, or dissimilar in different examples. For the sake of brevity, related features not be redundantly explained in each example. Instead, the use of related feature names will cue the reader that the feature with a related feature name may be similar to the related feature in an example explained previously Features specific to a given example will be described in that particular example. The reader should understand that a given feature need not be the same or similar to the specific portrayal of a related feature in any given figure or example.

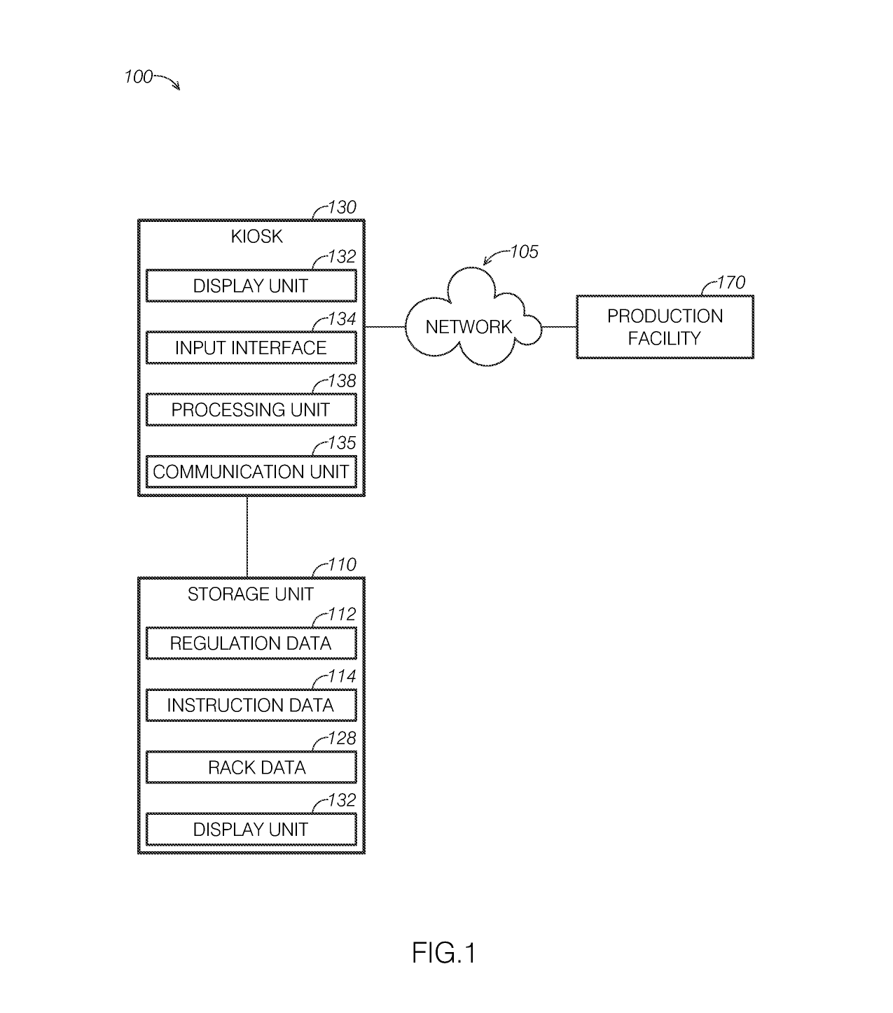

With reference to FIGS. 1-4, a first example of a system for producing military decoration racks, system for producing military decoration racks 100, will now be described. As FIG. 1 illustrates, system for producing military decoration racks 100 includes a storage unit 110, a kiosk 130, and a production facility 170. System for producing military decoration racks 100 is configured to design decoration racks for the United States Armed Forces by default, but may be configured to produce award racks and/or other similar displays for armed forces other than the United States military. Likewise, the system may be configured to produce award racks for non-military contexts.

By placing a decoration rack design kiosk, such as kiosk 130, in the AAFES store, many of the aforementioned problems with the existing AAFES system of ordering medal racks are mitigated. First, by implementing one or more kiosks within a retail space, the need to speak to an went is greatly reduced. Additionally, the kiosks provide ample visual feedback throughout the design process. Because the kiosk stores electronic records, customers can retrieve records in case of an error.

By accessing updateable online information and keeping accurate records of per-transaction pricing, the kiosk in the retail space ensures accurate pricing of orders.

Additionally, kiosks similar to those disclosed are configured to communicate orders directly to the rack supplier. This reduces communication errors on the part of AAFES agents. Additionally, this direct line of communication may be used for service and repair purposes, avoiding the need for AAFES to provide customer service for issues beyond the ordering process.

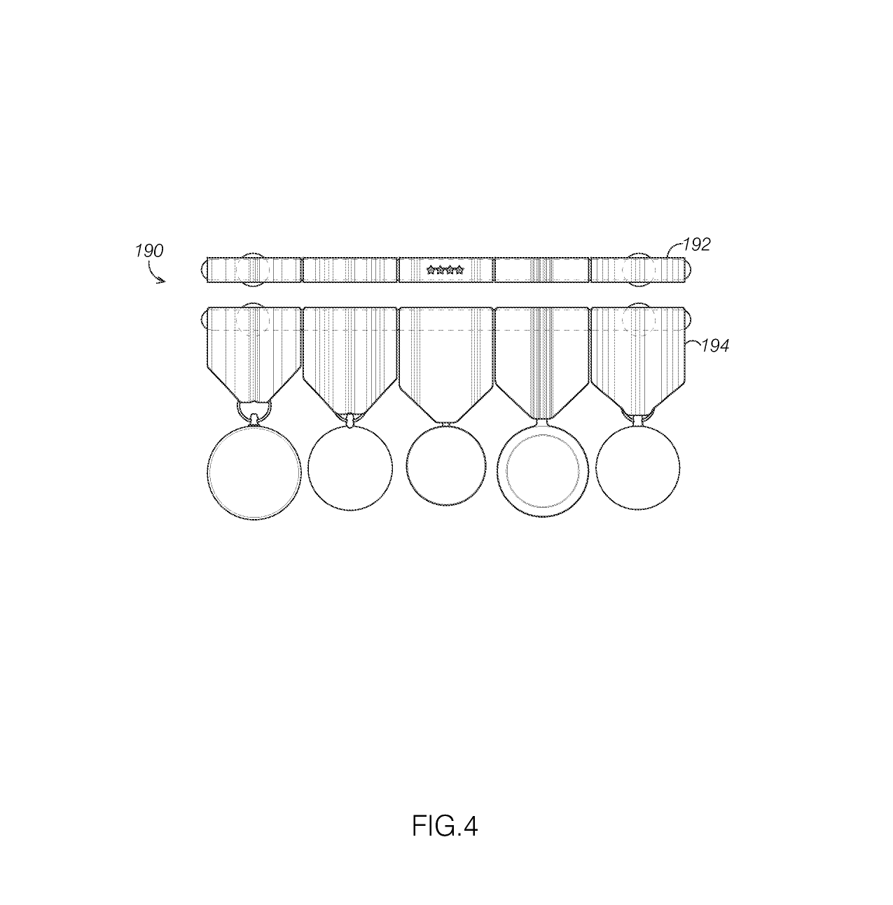

FIG. 4 illustrates an example of a decoration rack, rack 190, that system 100 is configured to design. As FIG. 4 shows, rack 190 includes a ribbon 192 and a medal 194. System 100 is configured to produce decoration racks that include medals, ribbons, any other common military decoration, any combination thereof.

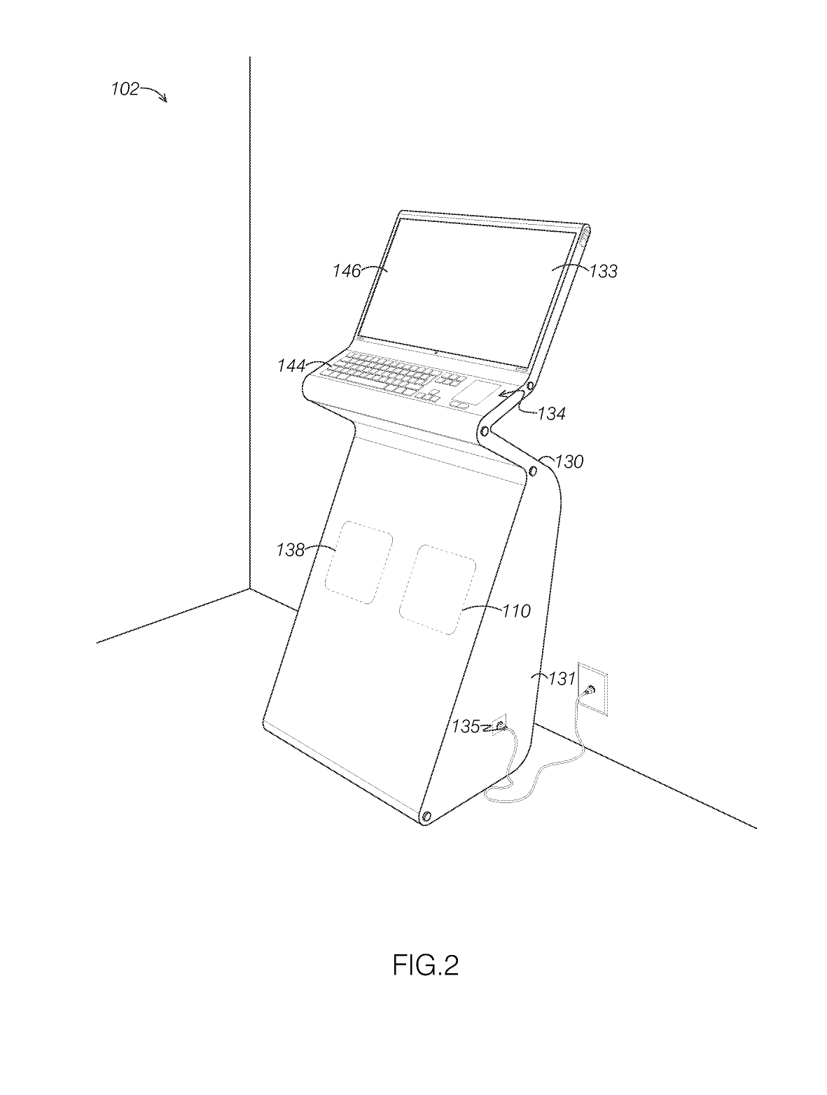

As FIG. 2 illustrates, system for producing military decoration racks 100 includes a kiosk 130 present in a military related retail space 102. Military related retail space 102 defines an AAFES store located on a military base within the United States. However, suitable retail spaces include those not affiliated the United States Armed Forces or the United States government. In some examples, kiosks may be present in retail spaces outside the United States. In other examples, kiosks may be present in retail spaces related to armed forces of other than the United States Armed Forces. In yet other examples, kiosks may be present within retail spaces related to the military other than AAFES stores, including other locations within a military base.

Placing kiosk 130 in military related retail space 102 confers a user with benefits compared to using similar systems in other locales. For example, the user has the opportunity to consult employees and/or agents of the retail space as they design their rack. This may make their ordering process more efficient. Additionally, placing kiosks in AAFES stores provides the benefit of grouping the military decoration tack point of purchase with that of other military related purchases.

Placing kiosks in military related retail spaces additionally may additionally provide the military related retail spaces a revenue stream. For example, the retail space may be able to strike a fee agreement whereby the kiosk owner allows the owner to lease space in which the kiosk is to be placed. Additionally, the placement of kiosks in military related retail spaces provides the proprietors of systems with an avenue for marketing their system.

As FIG. 2 illustrates, kiosk 130 is located within a military related retail space 102. FIG. 2 shows that kiosk 130 includes a display unit 132, an input interface 134, a communication unit 135, and a processing unit 138. As FIG. 2 illustrates, kiosk 130 additionally defines an enclosure 131.

As FIG. 2 shows, display unit 132 defines an electronic display attached to enclosure 131 and includes a screen 133. As FIG. 2 illustrates, display unit 132 additionally includes a touchscreen 146 configured to receive user input in response to a user's interaction with the screen.

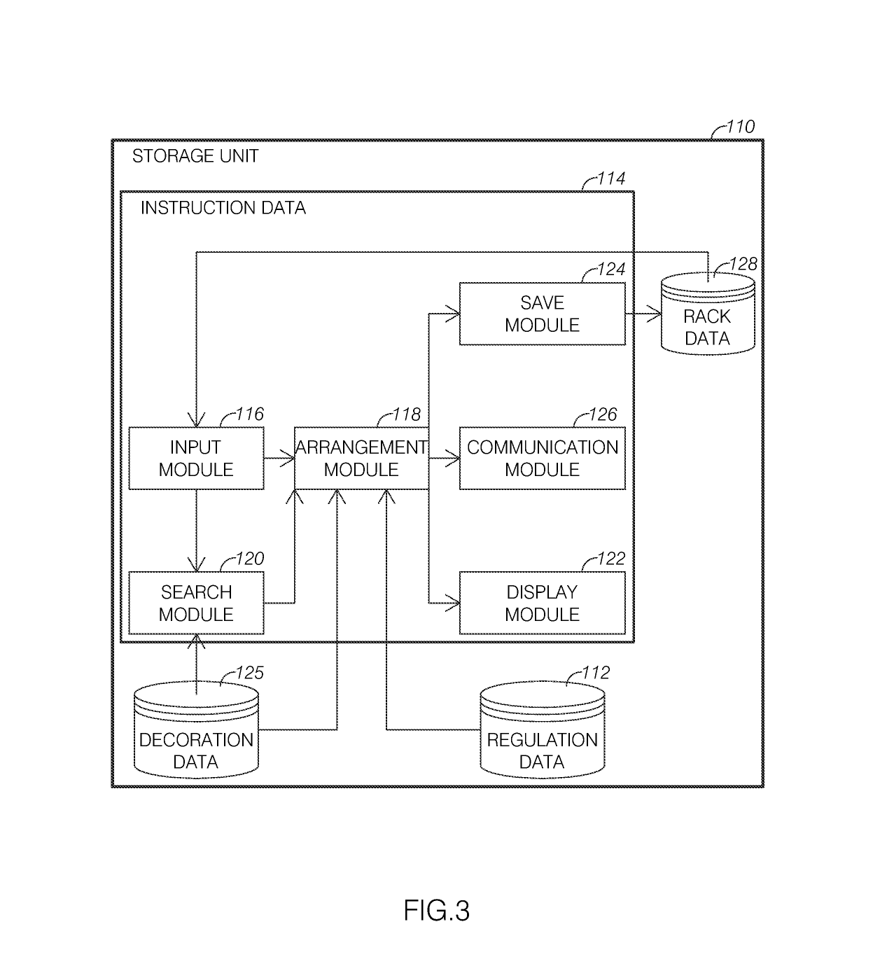

As FIG. 2 illustrates, input interface 134 includes the elements of kiosk 130 configured to respond to a user's interaction. As FIG. 3 shows, kiosk 130 is configured to communicate this interaction to input module 116. As FIG. 2 shows, input interface 134 includes a keyboard 144, a pointing device 145, and touchscreen 146.

With reference to FIG. 2, processing unit 138 defines computer processor contained in kiosk 130. Processing unit 138 is configured to execute instruction data 114 received from storage unit 110. More specifically, processing unit 138 is configured to receive instruction data 114 from storage unit 110 and perform the instructions encoded in the received instruction data. Processing unit 138 is additionally capable of communicating with storage unit 110 and external computer networks, including the internet. As a result, processing unit 138 may communicate with remote and local memory/storage as it executes instruction data.

As FIG. 2 illustrates, communication unit 135 defines a network interface configured to be electronically to a computer network via a wire. Communication unit 135 is configured to receive data from the storage unit and to transmit data to the production facility. More specifically, communication unit 135 is configured to transmit rack data over a computer network, which may define the internet in some contexts.

As FIG. 2 illustrates, storage unit 110 defines electronic data storage in electrical. communication with kiosk 130. More precisely, storage unit 110 defines a hard drive contained within enclosure 131. As FIG. 3 illustrates, storage unit 110 electronically stores regulation data 112, instruction data 114, decoration data 125, and rack data 128. The data stored by storage unit 110 is used by kiosk 130 to generate and/or save rack data corresponding to input: data transmitted to kiosk 130 by a user. Storage unit 110 is configured to update any of the contained data without physically manipulating kiosk 130. As a result, kiosk 130 may be configured to access updated regulation data, instruction data, decoration data, and rack data.

Decoration data 125 is a dataset that corresponds to the decorations supported by system 100. For example, decoration data in systems within the United States include all military decorations which recognize service and personal accomplishments while a member of the United States armed forces. Decoration data 125 includes data corresponding to medals and ribbons, similar to medal 194 and ribbon 192 shown on rack 190 in FIG. 4. As previously mentioned decoration data 125 may automatically be updated on storage unit 110 without manually updating of kiosk 130.

Regulation data 112 includes data corresponding to the proper arrangement of decorations according to relevant regulations. For example, for systems used within the United States, regulation data 112 includes data corresponding to awards sections for U.S. Army AR 670-1, U.S. Marine Corps MCO P1020.34G, U.S. Navy Uniform Regulations, U.S. Air Force AFT 36-293, and U.S. Coast Guard COMDTINST M1020.6E. As previously mentioned, decoration data 125 may be updated automatically on storage unit 110 without manually updating, of kiosk 130.

Rack data 128 is a dataset that corresponds to a selected se, of decorations included on a designed or partially designed rack. Rack data 128 includes data that corresponds to an arranged rack, similar to rack 190, and includes data corresponding to medals and ribbons selected from decoration data 125 arranged according to regulation data 112.

Instruction data 114 defines a collection of computer instructions electronically stored on storage unit 110, Instruction data 114 may include instructions stored in any computer-readable format, and may comprise instructions stored in binary and or text-based tiles. Instruction data 114 is described herein as having a collection of modules that are configured to perform particular functions. However, there is no requirement for the code to be stored and/or executed in such a segregated manner. Individual files, programs, executables, scripts, or other instructions sent to processing unit 138 may be configured to perform multiple modules, such as those described below, either in whole or in part.

With reference to FIG. 3, instruction data 114 includes an input module 116, an arrangement module 118, a search module 120, a display module 122, a save module 124, and a communication module 126.

Input module 116 is configured to receive user input from the input interface and/or tack data previously saved to storage unit 110. Input module 116 translates the user input to input data that is compatible with arrangement module 118.

Input module 116 may retrieve input data from remote data sources, such as sources remotely accessible through computer networks. This disclosure specifically contemplates input modules that may retrieve data entered at other kiosks or data entered within other compatible software systems.

Arrangement module 118 is configured to translate the input data into rack data that defines configured a military decoration rack arranged according to regulation data 112. More specifically, arrangement module 118 selects decorations from decoration data 125, the decorations potentially including medals and/or ribbons, and arranges the decorations into a particular order that conforms with regulation data 112.

Display module 122 is configured to display a visualization on display unit 132 corresponding to a rack currently being designed, Display module 122 updates the display data upon arrangement module 118 to produce new rack data 128 and retransmits the updated display data to display unit 132. As a result, a user is presented with a graphical representation of their arranged rack that is updated in real-time in response to their input, Display module 122 is additionally configured to generate a user interface that provides elegant instruction as to ho the user should interact with input interface 134.

Search module 120 is configured to use the input data to select decoration data from the storage unit and add the selected decoration data to the rack data, Search module 120 uses input data and display unit 132 to allow a user to more simply select from the contents of decoration data 123. For example, search module 120 may display a visualization of a decoration on display unit 132 in response to a user entering a partial description of a decoration referenced in decoration data 125.

Communication module 126 is configured to communicate rack data produced by arrangement module 118 to production facility 170 via communication unit 135 upon an indication that the rack data is complete and requires no further updating prior to production. At the time that communication module 126 communicates the rack data, it may additionally provide the user with electronic confirmation of the order. In examples connected to the internet, this may be accomplished by automatically sending an e-mail to the customer's e-mail address.

By allowing a user to control the process of ordering decoration racks from the beginning of the process to the communication of the order to production facility 170, system for producing military decoration racks 100 confers several benefits to the user. For example, by displaying display data responsive to selectively updated rack data, users are able to view their rack as they create it. Compared to waiting for an available agent at a participating retail space, a current common method of decoration rack design, system 100 provides an easier and faster method of ordering a decoration rack. In particular, this provides users with the ability to personally create their racks within a military related retail space without the time-consuming process of waiting for an available agent and working through a design without adequate visualizations of the completed rack.

Additionally, by producing updated visual representations of a rack while designing the rack and delivering the rack data directly to production facility 170, system for producing military decoration racks 100 lessens the chance of mistake in the design and submission process. This is true in cases wherein the user is assisted by an agent of the military related retail space and in cases where the user is unassisted.

Save module 124 is configured to store a user's current rack to storage unit 110 or an external electronic storage medium at a selected point during design. Save module 124 is specifically configured to connect to external systems over a computer network, which may define the internet, to store a user's current rack data. Save module 124 produces an electronic copy of a user's tack data, which may be retrieved at a later date to complete a partially completed design. This saved rack data may also be used when a user earns additional decorations. By saving an electronic copy, save module 124 lessens the risk of loss that results from producing physical copies alone. Additionally, save module 124 allows a user to access her rack data from compatible kiosks and/or other compatible terminals aside from the specific one in which she began the design process.

As FIG. 1 illustrates, kiosk 130 is in data communication with production facility 170. More precisely, communication module 126 is configured to transmit rack data generated by arrangement module 118 to production facility 170 upon a user determining the rack data is sufficiently arranged to begin. production. As FIG. 1 illustrates, production facility 170 is in data communication with kiosk 130 through a computer network, wherein arranged rack data is transmitted digitally to production facility 170. Production. facility 170 is at a different location than kiosk 130, and communication module 126 is configured to electronically communicate over the computer network to production facility 170's remote location.

However, this disclosure additionally contemplates production facilities proximate the kiosk, and specifically contemplates production facilities physically connected to the kiosk. In such examples, a device connected to the kiosk may provide a user with an arranged rack at nearly the same time and location. to where the user entered input data into the kiosk.

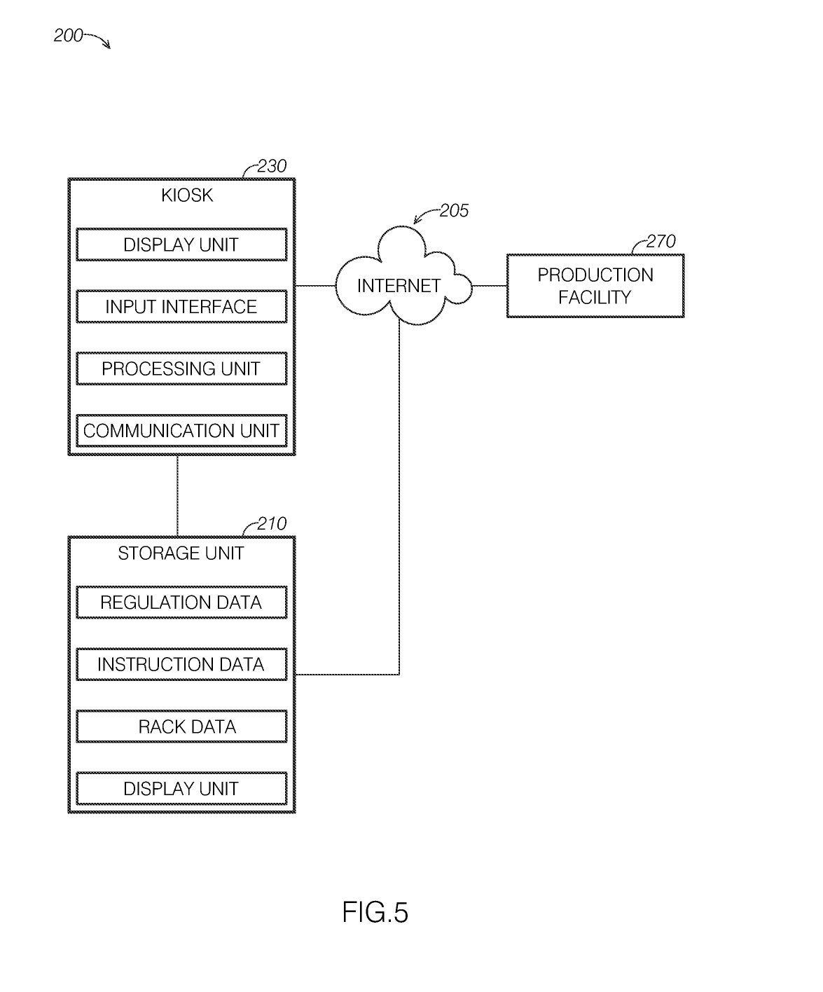

With reference to FIG. 5, a second example of a system for producing military decoration. racks, system for producing military decoration racks 200, will now be described. System for producing military decoration racks 200 is substantially similar to system for producing military decoration racks 100 and includes a kiosk 230, storage unit 210, and a production facility 270, each substantially similar to the corresponding elements of system for producing military decoration racks 100. A difference between system 200 and system 100 is seen in the way storage unit 210 is connected to kiosk 230. Rather than being directly connected to the kiosk, storage unit 210 is connected to kiosk 230 over the internet. Kiosk 230 is configured to retrieve data from storage unit 210, including instruction data, and execute and/or manipulate that data locally. Specifically, kiosk 230 includes an internet browsing application configured to retrieve the data, allow the kiosk to process the data locally, and then output rack data to production facility 270.

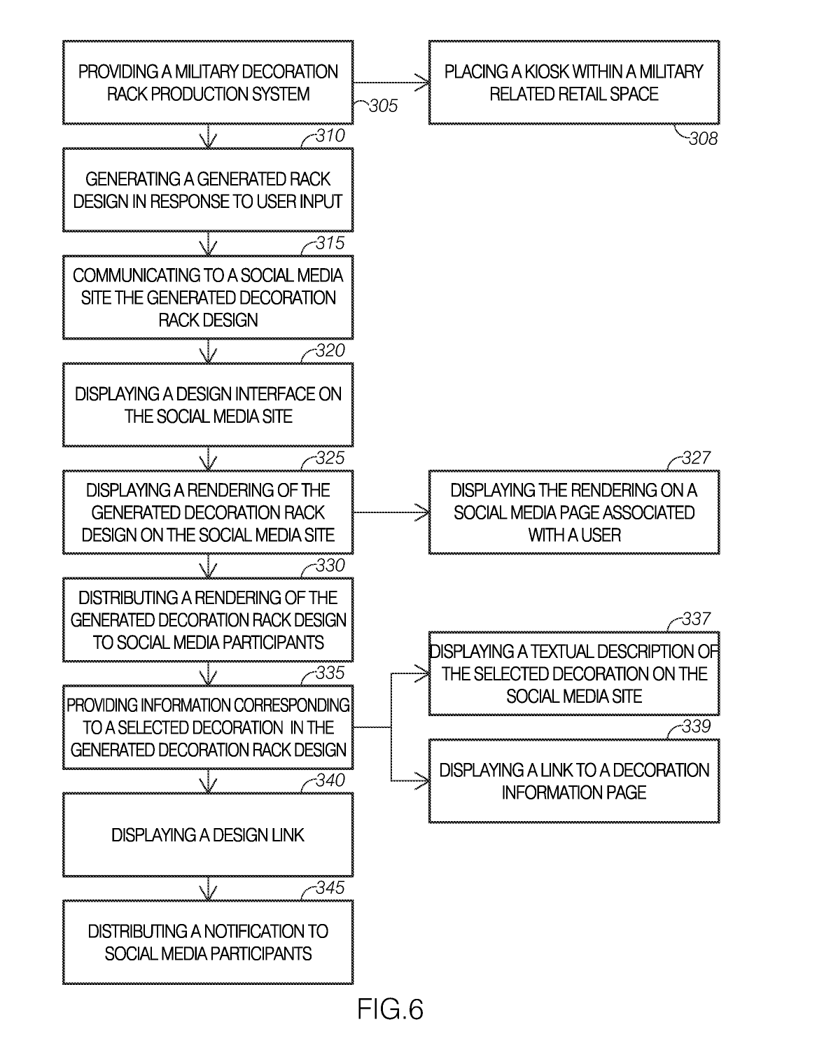

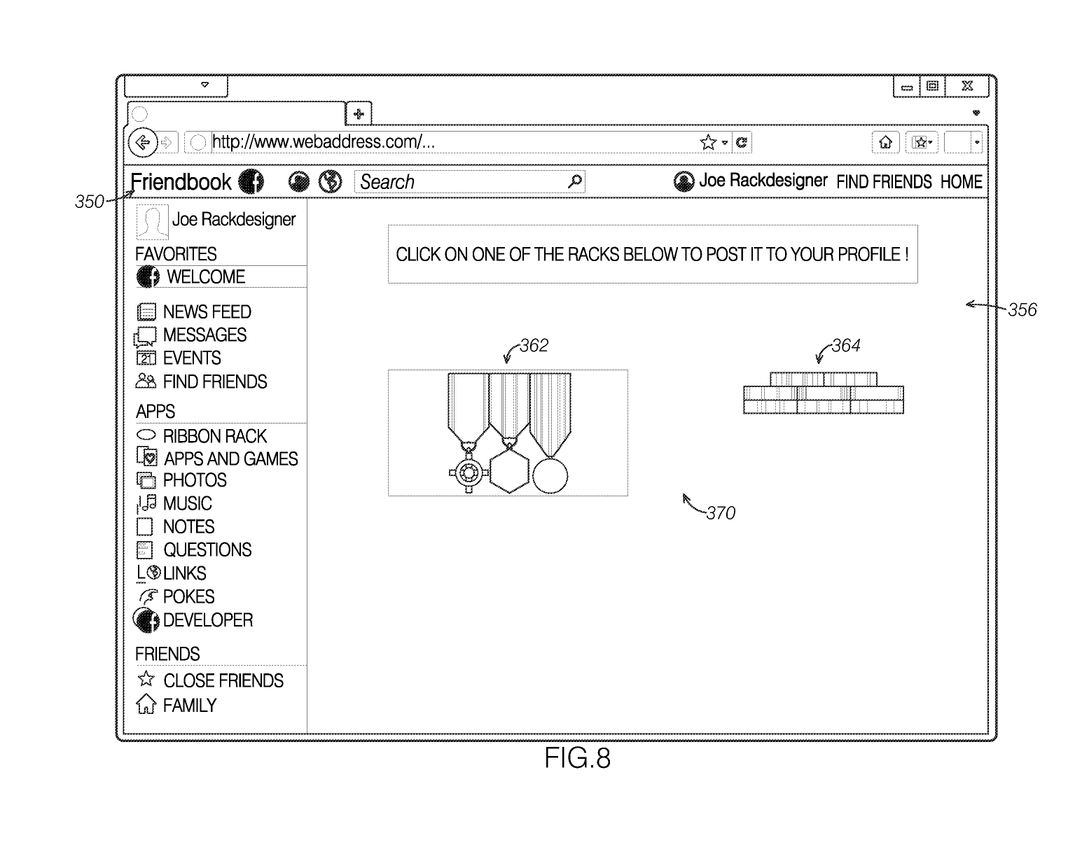

With reference to FIGS. 6-11, an example of a method for communicating military decoration rack designs, method 300, will now be described. As FIG. 6 illustrates, method 300 includes Providing a military decoration rack production system at step 305, generating a generated rack design in response to user input at step 310, communicating to a social media site the generated rack design at step 315, displaying a design interface on the social media site at step step 320, displaying a rendering of the generated decoration rack design on the social media site at step 325, distributing a rendering of the generated decoration rack design to social media participants at step 330, providing information corresponding to a selected decoration in the generated decoration rack design at step 335, displaying a design link at step 340, and distributing a notification to social media participants at step 345. As FIGS. 8-11 illustrate, method 300 allows users to display military decoration rack designs to friends and other social networking participants linked to them over a social network. This provides users with a convenient way of displaying to social networking participants achievements they received in the course of military duty. Further, by allowing the user to notify social networking participants of updates to a generated rack, the user may easily update the participants as the user receives additional achievements.

As FIG. 6 illustrates, a military decoration rack production system in data communication with a computer network is provided at step 305. The military decoration rack production system may include many features similar to those of system for producing military decoration racks 100. For example, method 300 includes an input interface, a storage unit, and a processor unit substantially to those of system for producing military decoration racks 100. Further, the storage unit includes instruction data including an arrangement module including processor executable instructions to generate a decoration rack in response to user input via the input interface. In some examples, the arrangement module further includes processor executable instructions to generate a decoration rack design that conforms to a set of design regulations, such as the order of precedence of United States Armed Forces decorations. This arrangement module automates the often laborious task of arranging compliant decoration racks by automatically generating a conforming decoration rack in response to user input corresponding to earned achievements.

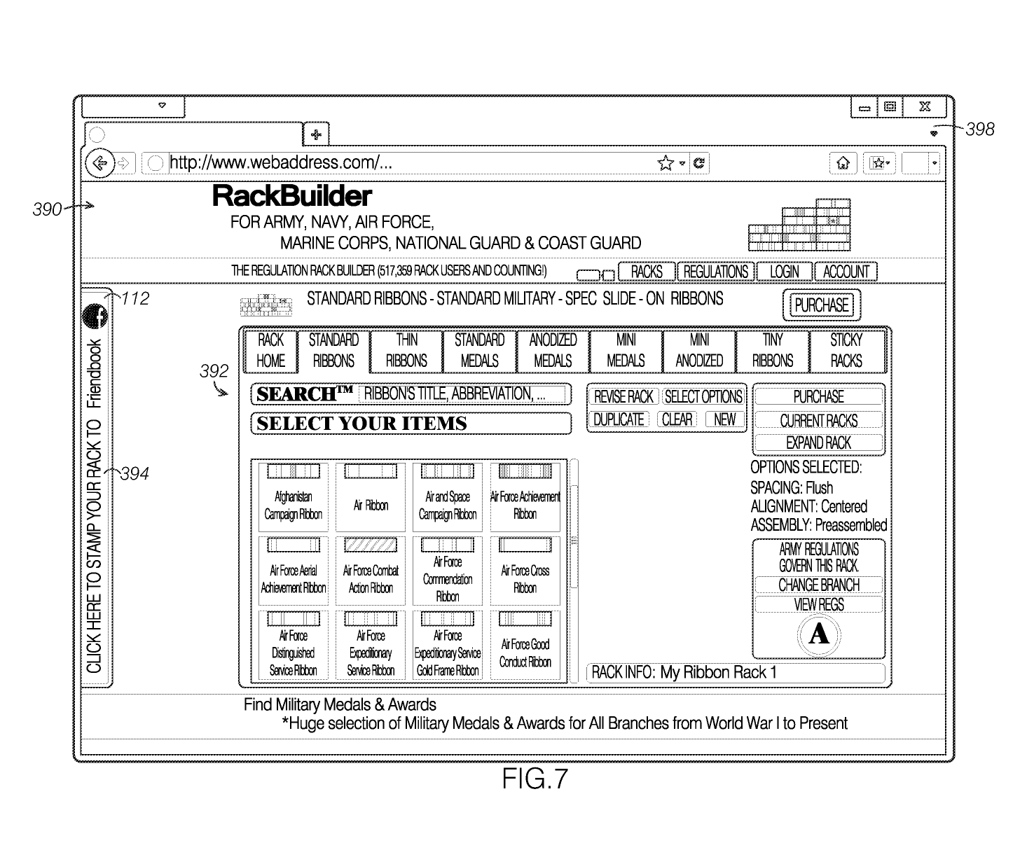

As FIG. 7 illustrates, the military decoration rack production system may host a rack design website 390 including a rack design web interface 392. In many examples, the user may access rack design. website 390 using a web browser. For example, FIG. 7 illustrates an example screenshot of a web browser 398 accessing rack design website 390 on a client computer to input received achievements via a graphical user interface. Rack design web interface 392 is configured to generate a rack design in response to the user input corresponding to the user's received achievements. Further, rack design website. 390 may optionally display during the design process. Racks generated on rack design web interface 392 may be saved to a server computer hosting rack design website 390; these saved rack designs may be amended by the user at a later date.

As FIG. 7 shows, providing a generated decoration rack production system at step 305 may in some examples include placing a kiosk within a military related retail space at step 308. This kiosk may, for example, be similar to kiosk 130 and be in data communication with the military decoration rack production system. The kiosk may further be configured to communicate user input entered on the kiosk to the input interface.

As FIG. 6 illustrates, a generated decoration rack design is generated in response to user input from the user at step 310. As previously discussed, rack design website 390 includes a rack design web interface 392 that allows the user to generate a decoration rack design in response to user input on a client computer connected to rack design website 3913, Rack design web interface 392 may further save that rack data to the server computer hosting rack design website 390. In some cases, saved decoration rack designs may be retrieved from the server computer. The user may then generate a rack design defining an amendment to the saved rack. Amending saved racks may be particularly useful for experienced users who have received new awards since designing their first rack on the military rack production system.

As FIG. 6 shows, the generated rack design is communicated to a social media site at step step 315. Rack design website 390 is configured to communicate data to the social media site over a computer network, such as the internet. Communication may occur through software executed by the military rack production system implementing an application progamming interface allowing interaction between rack design website 390 and the social media site. In other cases, communication may occur by interfacing with a social media site application, such as a plug-in, written to operate on the social media site; as an example, the social media application may define a Facebook® application.

An example of a social media site that rack design website 390 may interact with, social media site 350, is shown in FIGS. 8-11. As FIGS. 8-11 show, social media site 350 includes a plurality of social media pages designed to allow a social media user to communicate with associated social media participants FIGS. 8-11 illustrate social media page examples, including a rack selection page 356, a rack posting page 357, a user page 358, and a rack design page 359. This allows the user to communicate with other social media participants ever the social media pages and through direct messaging, providing a convenient medium through which the user may communicate generated rack designs to selected groups of friends and acquaintances.

Common social media sites such as Facebook®, Google+®, LinkedIn®, and MySpace® provide examples contemplated social media sites; this disclosed methods, however, are not limited to these specific examples.

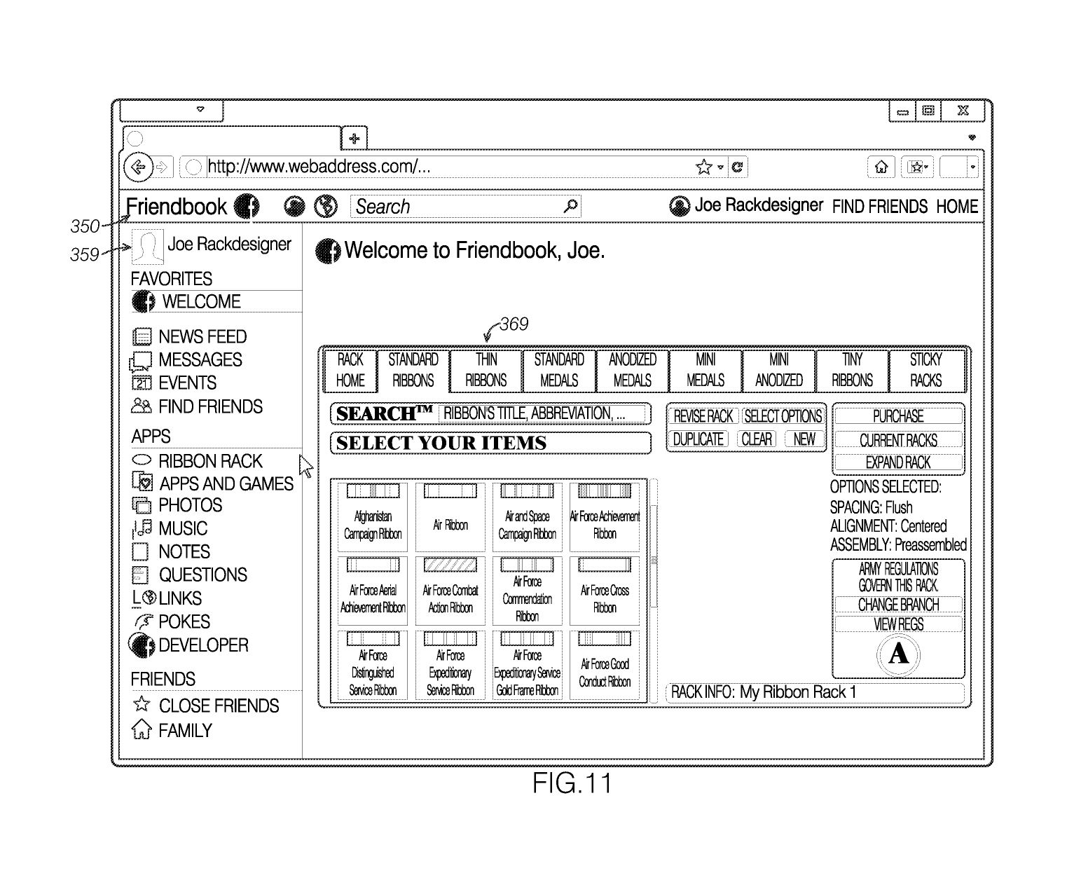

As FIG. 6 illustrates, a design interface, such as a social media site design interface 369, may be displayed on social media site 350, at step 320, Social media site design interface 369 may operate additionally or alternatively to rack design web interface 392. Social media site design interface 369 is configured to receive user input via social media site 350 and generate a decoration rack design in response to the user input. As FIG. 11, social media site design interface 369 may be implemented as a social media site application, such as a plug-in, written to operate on the social media site; as an example, the social media application may define a Facebook® application, This provides users with an alternative to rack design website 390, which may prove particularly convenient in cases where the user often displays generated decoration rack designs on social media site 350.

The examples illustrated in FIGS. 8-11 correspond to a user, Joe Rackdesigner, who has previously designed military decoration racks on rack design website 390 or social media site design interface 369.

As FIG. 6 illustrates, a rendering of the generated decoration rack design is displayed on social media site 350, on which the user has an account, at step 325. The rendering may be displayed in response to user input; for example, FIG. 7 Illustrates a case wherein the user may select to display the generated rack design by pressing a stamp button 394. In response to the user pressing the button, rack design website 390 would execute instructions configured to communicate the generated rack design to social media site 350 and cause social media site 350 to display a rendering based on the generated rack design, likely as a posting on a user page corresponding to the user.

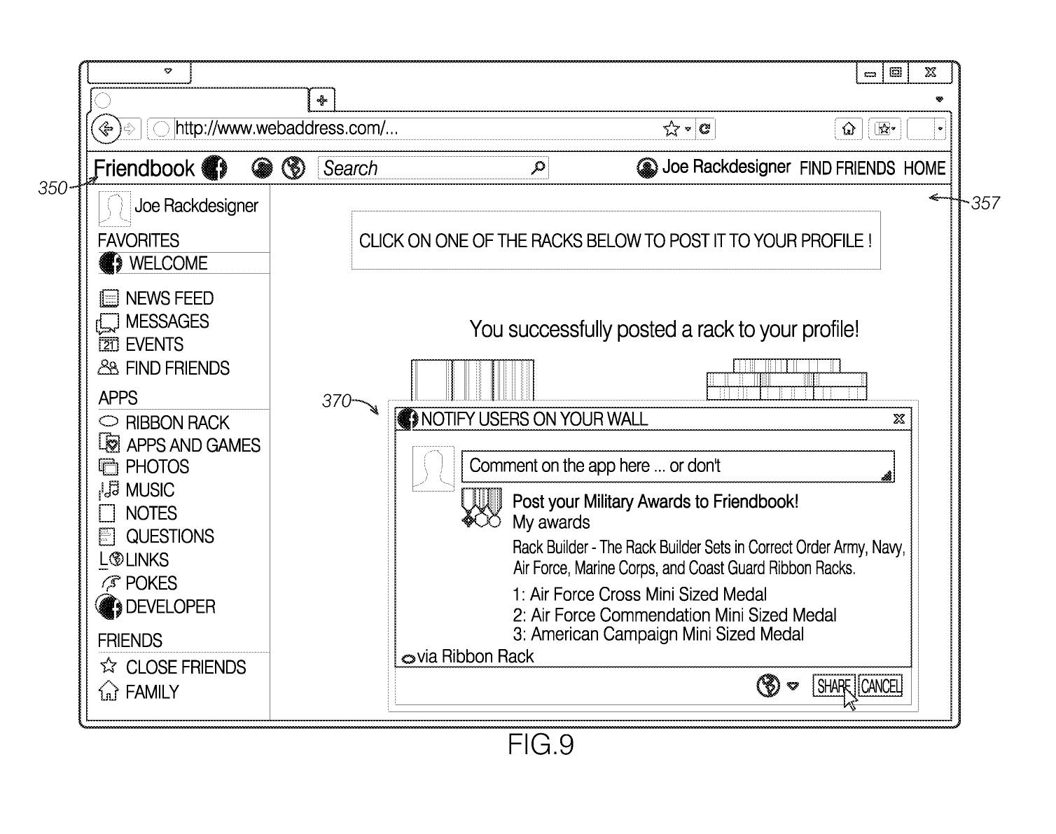

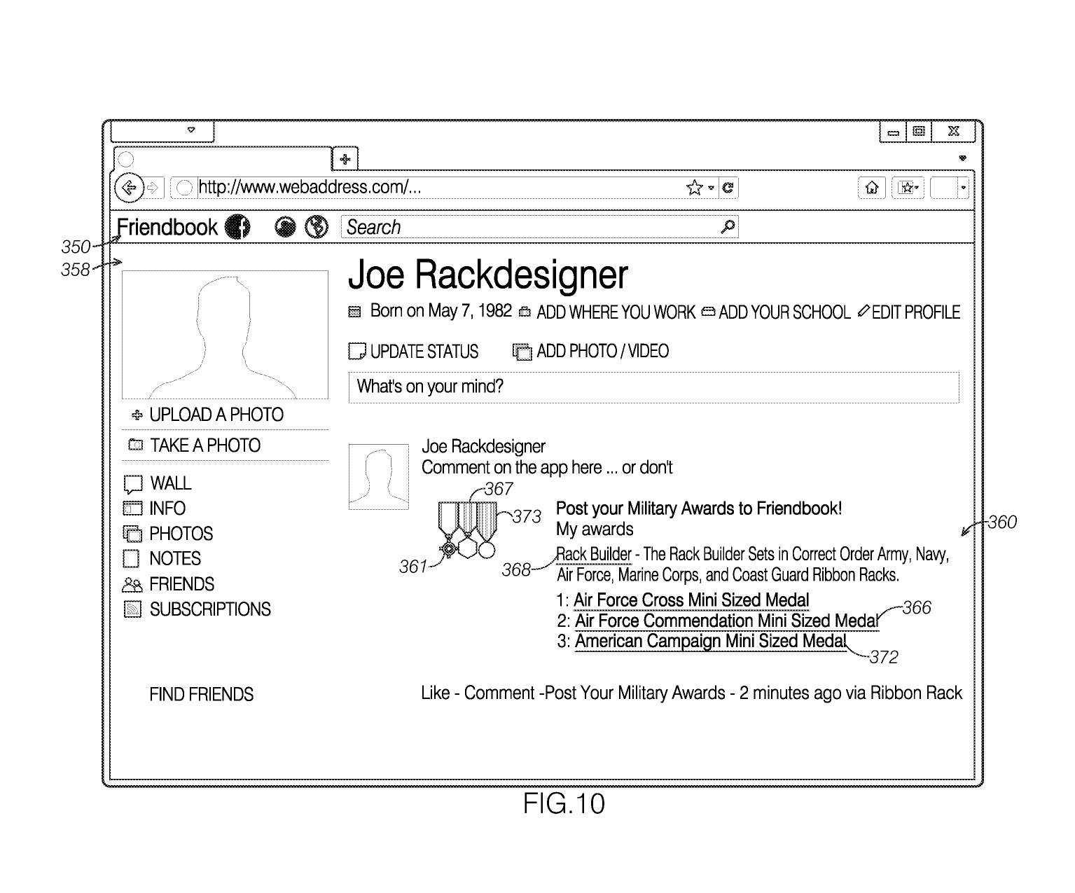

In other examples, the generated rack design may be displayed on social media site 350 in response to user interaction with a social media site application, such as social media stamping application 370. FIGS. 8 and 9 illustrate social media stamping application 370 in two example stages of operation: a first stage where the user selects a rack design and a second stage where the user may provide additional information corresponding to the selected rack design. When the user provides appropriate input, social media stamping application 370 displays a generated rack design on one or more social media pages associated with the user's account. FIG. 10 illustrates an output 360 produced by social media stamping application 370. As FIG. 10 shows, output 360 includes a rendering 361 corresponding to a selected generated rack design displayed on user page 338. Once displayed on user page 358, rendering 361 may be viewed social media participants associated with the user.

In some cases, selecting stamp button 394 may y direct the user to social media stamping application 370 rather than immediately posting a rendering on social media site 350, As FIGS. 8 and 9 illustrate, social media stamping application 370 and stamp button 394 may, in some examples, allow users to select one or more generated rack designs from a collection and display a rendering associated with the selected generated rack design. In some example cases, renderings of decoration rack designs may be displayed on social media pages automatically during the design process. In other example cases, renderings of decoration rack designs may automatically be displayed on social media pages upon passage of a selected time interval.

Although the displayed rendering often defines a computer-generated graphical representation of an arrangement of decorations corresponding to the generated decoration design, such as the example displayed in FIG. 10, this is not specifically required. In some cases, for example, the displayed rendering may define a textual representation or description.

As FIG. 6 illustrates, a rendering of the generated decoration rack design is distributed to social media participants associated with the user at step 330. In some cases, the rendering may be distributed via a posting the rendering on a social media page associated with the user, such as output 360. In other example cases, however, the rendering may be distributed via a direct messaging feature of the social networking site or another internet service, such as e-mail.

As FIG. 6 illustrates, information corresponding to a selected decoration in the generated decoration rack design is provided at step 335. As FIG. 6 shows, providing the information may include displaying on the social media site a textual description of the selected decoration at step 337. FIG. 10 provides an example of such a textual display: output 360 includes a textual description 366 corresponding to a first decoration 367. Although textual description 366 includes only the name of the decoration, other textual description examples may provide additional information, such as the standards for receiving the corresponding award, the acts performed to receive the corresponding the award, or other relevant information.

As FIG. 6 illustrates, providing the information may include displaying on the social media. site an information link to a decoration information page. FIG. 10 illustrates such an example: an information link 372 is configured to direct social media participants to a page providing information about a second decoration 373. In some examples, the page may be a page present on rack design website 390. In others, the information link may be directed to a page associated with an armed services organization, government, or other site providing information about military decorations.

As FIG. 6 illustrates, a design link configured to direct social media participants associated with the user to a rack configuration system is displayed at step 340. FIG. 10 illustrates an example of such a design knit link 368, configured to direct social media participants to rack design web interface 392 hosted on rack design website 390. In other examples, design links may direct social media participants to a social media page or social media application hosted on the social media site, such as social media site design interface 369.

As FIG. 6 illustrates, a notification is distributed to social media participants at step 345. In some examples, the notification may be distributed by posting on a social media page, such as output 360 shown in FIG. 10. In of examples, notifications may be distributed by direct messaging services operated by the social media site. In yet further examples, notifications may be distributed via another internee service, such as e-mail.

The distributed notification references, either in whole or in part, a generated rack design associated with the user. For example, the notification may include rack displays or information corresponding to decoration rack designs, information corresponding to amendments, or other information about the user's rack. Distributing a notification may be particularly useful to allow the user to update social media participants, including friends and family, on newly received awards. Indeed, this disclosure specifically contemplates examples of notifications including information about new awards associated with saved design racks that include minimal reference the original rack.

The disclosure above encompasses multiple distinct inventions with independent While each of these inventions has been disclosed in a particular form, the specific embodiments disclosed and illustrated above are not to be considered in a limiting sense as numerous variations are possible, The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method for communicating military decoration rack designs designed by a user, comprising:
providing a military decoration rack production system in data communication with a computer network, the military decoration rack production system including:
an input interface configured to receive user input;
a storage unit storing instruct ion data, the instruction data including an arrangement module including processor executable instructions to generate a decoration rack design in response to the user input; and
a processing unit configured to execute the instruction data;
generating a generated decoration rack design in response to user input from the user;
communicating to a social media site the generated decoration rack design, wherein the user has an account on the social media site; and
displaying a rendering of the generated decoration rack design on the social media site.

2. The method of claim 1, wherein displaying the rendering of the generated decoration rack design on the social media site includes displaying the rendering on a social media page associated with the user.

3. The method of claim 1, wherein the military decoration rack production system hosts a website including a design interface configured to receive user input from the user as the user accesses the website with a web browser.

4. The method of claim 3, wherein the generated rack design is displayed on the social media site in response to the user selecting a stamping button displayed on the website.

5. The method of claim 1, wherein the generated rack design is displayed on the social media site in response to the user interacting with a social media site application configured to operate on the social media site.

6. The method of claim 1, wherein the rendering includes a graphical representation of art arrangement of decorations corresponding to the generated decoration rack design.

7. The method of claim 1, further comprising providing information corresponding to a selected decoration in the generated decoration rack design,

8. The method of claim 7, wherein providing information corresponding to the selected decoration in the generated decoration rack design includes displaying on the social media site a textual description of the selected decoration.

9. The method of claim 7, wherein providing information corresponding to the selected decoration in the generated decoration rack includes displaying on the social media site an information link to a decoration information page.

10. The method of claim 9, wherein the decoration information page is hosted by the military decoration rack production system.

11. The method of claim 1, further comprising displaying on the social media site a design link configured to direct social media participants to a rack configuration system.

12. The method of claim 11, wherein the rack configuration system defines the military rack production system.

13. The method of claim 1, further comprising displaying design interface on the social media site.

14. The method of claim 1, wherein providing a military decoration rack production system includes placing a kiosk within a military related retail space, the kiosk in data communication with the military decoration rack production system and configured to communicate user input entered on the kiosk to the input interface.

15. The method of claim 1, wherein the input interface is configured to receive user input from a client computer connected via the computer network.

16. The method of claim 1, wherein the arrangement module includes processor executable instructions for generating the decoration rack design to conform to a set of design regulations corresponding to the order of precedence of United States Armed Forces decorations.

17. The method of claim 1, further comprising distributing a notification to social media participants associated with the user, the notification referencing the generated decoration rack design.

18. The method of claim 1, wherein:
the storage unit is storing a saved decoration rack design; and
generating the generated decoration rack design defines amending the saved decoration rack design. in response to user input from the user.

19. A method for communicating military decoration rack designs designee by a user, comprising:
providing a military decoration rack production system, in data communication with a computer network, the military decoration rack production system comprising:
an input interface configured to receive user input;
a storage unit storing instruction data, the instruction data including an arrangement nodule including processor executable instructions to generate a decoration rack design in response to user input; and
a processing unit configured to execute the instruction data;
generating a generated decoration rack design in response to input from the user;
communicating to a social media site the generated decoration rack design, wherein the user who configured the generated decoration rack design has an account on the social media site; and
distributing a rendering of the generated decoration rack design to social media participants associated with the user.

20. A method for communicating decoration rack designs, comprising:
providing a military decoration rack production system in data communication with a computer network, the military decoration rack production system comprising:
an input interface configured to receive user input;
a storage unit storing instruction data, the instruction data including an arrangement module including processor executable: instructions to generate a decoration rack design in response to user input; and
a processing unit configured to execute the instruction data;
generating a generated decoration rack design in response to input from the user;
communicating to a social media site the generated decoration rack design, wherein the user who configured the generated decoration rack design has an account on the social media site; and
displaying on the social media site a design link configured to direct social media participants to a website hosted by the military decoration rack production system.
